(19) United States
(12) Patent Application Publication
(10) Pub. No.: US 2007/0286783 A1
(43) Pub. Date: Dec. 13, 2007

(54) METHOD OF DEACIDIZING A GASEOUS EFFLUENT WITH EXTRACTION OF THE PRODUCTS TO BE REGENERATED

(76) Inventors: Pierre-Louis Carrette, Lyon (FR); Bruno Delfort, Paris (FR); Renaud Cadours, Francheville (FR); Arnaud Baudot, Vernaison (FR); Elsa Jolimaitre, Lyon (FR); Lionel Magna, Lyon (FR); Pierre Boucot, Ternay (FR)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/745,512

(22) Filed: May 8, 2007

(30) Foreign Application Priority Data
May 10, 2006 (FR) 06/04.102

(51) Int. Cl. B01D 53/48; B01D 53/50; B01D 53/62

(52) U.S. Cl. 423/228; 423/220; 423/226; 423/242.1; 423/242.6; 423/242.7

(57) ABSTRACT

The present invention relates to a method of deacidizing a gaseous effluent comprising at least one of the acid compounds as follows: H₂S, mercaptans, CO₂, COS, SO₂, CS₂, wherein the following stages are carried out: a) contacting the acid compounds contained in said effluent with reactive compounds forming a liquid, so as to obtain a gaseous effluent depleted in acid compounds and a first liquid fraction comprising products formed by reaction of the reactive compounds with acid compounds, and reactive compounds that did not react with acid compounds, b) contacting said products contained in the first liquid fraction with extraction compounds forming a second liquid fraction so as to obtain a product-depleted first liquid fraction and a product-enriched second liquid fraction, c) recycling to stage a) the first liquid fraction obtained in stage b), said first liquid fraction obtained making up at least part of said liquid, d) regenerating the second liquid fraction obtained in stage b) so as to release acid compounds in gaseous form and to obtain a mixture of reactive compounds and of extraction compounds.

### FIELD OF THE INVENTION

The present invention relates to the field of deacidizing a gaseous effluent.

### BACKGROUND OF THE INVENTION

Deacidizing gaseous effluents such as, for example, natural gas, synthesis gas, combustion fumes, refinery gas, Claus tail gas, biomass fermentation gas, cement works gas, blast-furnace gas, is generally carried out by washing with an absorbent solution. The absorbent solution allows the acid compounds present in the gaseous effluent to be absorbed.

Deacidizing these effluents, notably decarbonation and desulfurization, imposes specific requirements on the absorbent solution:
selectivity towards carbon dioxide in relation to oxygen and nitrogen in the case of fumes, in relation to hydrocarbons in the case of natural gas,
thermal stability,
chemical stability, notably towards the contaminants in the effluent, i.e. essentially oxygen, SOₓ and NOₓ, and
low vapour pressure, in order to limit absorbent solution losses at the top of the deacidizing column.

Currently, the most commonly used solvents are primary, secondary or tertiary aqueous alkanolamine solutions. In fact, the CO₂ absorbed reacts with the alkanolamine present in solution according to a reversible exothermic reaction.

An alternative to aqueous alkanolamine solutions is the use of hot carbonate solutions. The principle is based on the absorption of the CO₂ in the aqueous solution, followed by the reversible chemical reaction with the carbonates. It is well known that the addition of additives allows the solvent efficiency to be optimized.

Other decarbonation methods by washing with an absorbent solution such as, for example, refrigerated methanol or polyethylene glycols, are based on a physical absorption of the CO₂.

In general terms, the use of all the absorbent solutions described above involves a quite significant energy consumption for regeneration of the separation agent. Regeneration of the absorbent solution is generally carried out by entrainment by a vaporized gas commonly referred to as stripping gas. The thermal energy required for regeneration is split up in three parts linked with heating of the absorbent solution between the absorption stage and the regeneration stage (sensible heat of the absorbent solution), its vaporization heat and the binding energy between the absorbed species and the absorbent solution. The binding energy is all the higher as the physico-chemical affinity between the solvent compounds and the acid compounds to be removed is high. In the particular case of alkanolamines, it is more expensive to regenerate a very basic primary alkanolamine such as MonoEthanolAmine than a tertiary amine such as MethylDiEthanolAmine. The vaporization heat of the absorbent solution has to be taken into account since the thermal regeneration stage requires vaporization of a quite significant fraction of the absorbent solution in order to obtain the stripping effect that favours elimination of the acid compounds contained in the absorbent solution. This absorbent solution fraction to be vaporized is proportional to the extent of the association between the absorbed contaminant and the absorbent solution. However, an easily vaporizable absorbent solution is penalized by absorbent solution losses by entrainment upon contact between the gas feed to be treated and the absorbent solution. The part of the sensible heat is essentially linked with the absorption capacity of the absorbent solution: it is in fact proportional to the flow rate of the absorbent solution to be regenerated. The distribution of the energy cost of the regeneration stage between the sensible heat, the vaporization heat and the absorbed gas-absorbent solution binding enthalpy essentially depends on the chemical or physico-chemical properties of the absorbent solution and of the absorbed compound.

The present invention provides a method for deacidizing a gas, wherein the amount of energy required to regenerate an absorbent solution laden with acid compounds is minimized.

### SUMMARY OF THE INVENTION

In general terms, the present invention relates to a method of deacidizing a gaseous effluent comprising at least one of the acid compounds as follows: H₂S, mercaptans, CO₂, COS, SO₂, CS₂, wherein the following stages are carried out:
a) contacting the acid compounds contained in said effluent with reactive compounds forming a liquid, so as to obtain a gaseous effluent depleted in acid compounds and a first liquid fraction comprising products formed by reaction of the reactive compounds with acid compounds, and reactive compounds that did not react with acid compounds,
b) contacting said products contained in the first liquid fraction with extraction compounds forming a second liquid fraction so as to obtain a product-depleted first liquid fraction and a product-enriched second liquid fraction,
c) recycling to stage a) the first liquid fraction obtained in stage b), said first liquid fraction obtained making up at least part of said liquid,
d) regenerating the second liquid fraction obtained in stage b) so as to release acid compounds in gaseous form and to obtain a mixture of reactive compounds and of extraction compounds,
e) separating the mixture obtained in stage d) into a first stream enriched in reactive compounds and a second stream enriched in extraction compounds, recycling the first stream to stage a) and recycling the second stream to stage b).

According to the invention, said effluent can be contacted with the mixture obtained in stage d).

Stage a) can be carried out in a first zone and stage b) can be carried out in a second zone.

Alternatively, stages a) and b) can be carried out in a single contacting zone. In this case, said contacting zone can be a membrane contactor wherein the gaseous effluent circulates in a passage separated by a membrane from another passage wherein the reactive compounds and the extraction compounds circulate. Said contacting zone can also be a membrane contactor wherein the gaseous effluent circulates in a first passage separated by a first membrane from a second passage wherein the reactive compounds circulate, said second passage being separated by a second membrane from a third passage wherein the extraction compounds circulate.

Said reactive compounds can be selected from the list consisting of N,N-dimethylbenzylamine, N-ethylbenzylamine, 3-(octylamino)propionitrile and 3-(tertiobutylamino)propionitrile.

Said extraction compounds can be selected from the list consisting of water, glycol ethers, alkylene carbonates, dialkyl carbonates, sulfolane and N-methylpyrrolidone.

The present invention uses an absorbent solution having the property of absorbing the acid compounds contained in the gaseous effluent and of reacting therewith to form reaction products. These reaction products have the property of being preferably soluble in an extraction solution that has the specific feature of being immiscible or weakly miscible with the absorbent solution. This property allows to regenerate only the reactive compounds that reacted with the acid compounds of the gaseous effluent.

### BRIEF DESCRIPTION OF THE FIGURES

Other features and advantages of the invention will be clear from reading the description hereafter, with reference to the accompanying figures wherein:

FIG. 1 diagrammatically shows a first embodiment of the method according to the invention,

FIG. 2 diagrammatically shows a second embodiment of the method according to the invention,

FIGS. 3 and 4 show two alternatives to the embodiment of FIG. 1 using a membrane contactor,

FIG. 5 describes an example of internal operation of a three-way membrane contactor.

### DETAILED DESCRIPTION

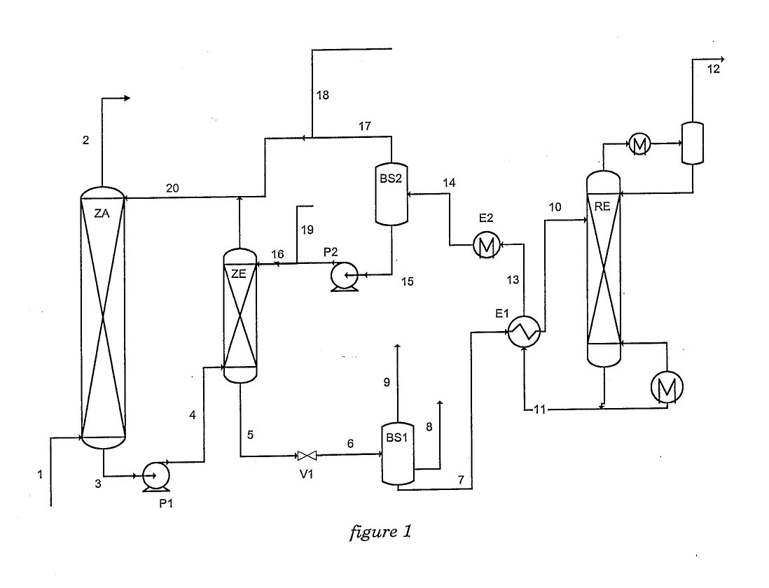

In FIG. 1, the gaseous effluent to be deacidized flows in through line 1. The deacidizing method diagrammatically shown in FIG. 1 can be applied for treating various gaseous effluents. For example, the method allows to decarbonate combustion fumes, to deacidize natural gas or a Claus tail gas. The method also allows to remove the acid compounds contained in synthesis gas, in conversion gas in integrated coal or natural gas combustion plants, and in the gas resulting from biomass fermentation.

Within the context of combustion fumes decarbonation, the typical composition of a gaseous effluent corresponds, by volume, to 75% nitrogen, 15% carbon dioxide, 5% oxygen and 5% water. Various contaminants such as SOₓ, NOₓ, Ar and other particles are also present in smaller proportions, they generally represent less than 2% by volume. The temperature of these fumes ranges between 50° C. and 180° C., the pressure is generally below 15 bars.

Natural gas essentially consists of 25% to 99% by volume of hydrocarbons, essentially methane, together with hydrocarbons having generally 2 to 6 carbon atoms. The presence of carbon dioxide in proportions ranging between 1% and 75% by volume CO₂ is often observed. Other contaminants, essentially sulfur compounds such as mercaptans, COS and H₂S, can be present in concentrations ranging from some ppm up to 50% by volume. Natural gas is generally available at pressures ranging between 20 and 100 bars, and at temperatures ranging between 20° C. and 60° C. The transportation, temperature and pressure conditions define the water content of this gaseous effluent.

Concerning Claus tail gases, their final treatment often involves hydrogenation and hydrolysis stages in order to convert all of the sulfur-containing species to hydrogen sulfide, itself collected by means of a deacidizing method using an alkanolamine-based solvent. A typical example of this method is the SCOT method. The gases to be treated during the absorption stage are then available at pressures often close to atmospheric pressure and at temperatures close to 50° C., conventionally ranging between 38° C. and 55° C. These gases contain on average less than 5% by volume of H₂S, most often less than 2%, up to 50% carbon dioxide, the rest of the gas essentially consisting of nitrogen. These gases can be saturated with water, for example they can contain about 5% by volume of water.

The other gaseous effluents requiring deacidizing for safety or transportation reasons, or according to their use, such as synthesis gas, conversion gas in integrated coal or natural gas combustion plants, gas resulting from biomass fermentation, have very variable availability conditions depending on their origin, notably as regards the temperature, pressure, composition of the gas and the acid gas concentrations.

In general terms, the acid compounds to be removed from the gaseous effluent flowing in through line 1 are Brönsted acids such as hydrogen sulfide (H₂S) or mercaptans, notably methylmercaptan and ethylmercaptan, and Lewis acids such as carbon dioxide (CO₂), sulfur dioxide (SO₂), or carbon oxysulfide (COS) and carbon disulfide (CS₂). These acid compounds are generally encountered in proportions ranging between some ppm and several percents, for example up to 75% for CO₂ and H₂S in natural gas.

The gaseous effluent flowing in through line 1 can be available at pressures ranging between atmospheric pressure and 150 bars, whether a natural gas or a combustion fume. In the case of low-pressure gaseous effluents, a compression stage can be considered in order to reach pressure ranges favouring implementation of the present invention. The temperature of this effluent generally ranges between 0° C. and 300° C., preferably between 20° C. and 180° C., considering a natural gas as well as a combustion fume. It can however be controlled (by heating or cooling) in order to favour capture of the acid compounds by the absorbent solution.

The gaseous effluent flowing in through line 1 is contacted in absorption zone ZA with the liquid absorbent solution flowing in through line 20. Conventional techniques for contacting a gas and a liquid can be used: bubble column, plate column, packed column, with random or stacked packing, stirred reactors in series, membrane contactors, etc.

The absorbent solution is selected for its aptitudes to absorb the acid compounds in zone ZA. The gaseous effluent depleted in acid compounds is discharged from zone ZA through line 2. The absorbent solution laden with acid compounds is discharged from zone ZA through line 3.

The deacidizing absorbent solution is selected for its aptitude to absorb the acid compounds. The absorbent solution consists of one or more reactive compounds reacting with acid gases. The present invention relates to all the compounds whose reaction with H₂S, or CO₂ or SO₂, or mercaptans, or COS or CS₂ leads to the formation of products that are substantially more soluble in the extraction solution than in the absorbent solution.

The nature of the reactive compounds of the absorbent solution can be selected according to the nature of the acid compound(s) to be treated in order to allow a reversible chemical reaction with the acid compound(s) to be treated. The chemical structure of the reactive compounds can also be selected so as to furthermore obtain an increased stability for these compounds.

The absorbent solution can also comprise salvation compounds. These compounds can be all the compounds that dissolve in sufficient amount the reactive compounds or that are miscible with the reactive compounds and weakly miscible with the extraction solution. They can be, for example, hydrocarbons, branched or not, cyclic or not, aromatic or not. By way of example, toluene, ethylbenzene, xylenes, nitrobenzene, chlorobenzenes, fluorobenzenes, decalin, tetralin, kerosine, petroleum ethers can be mentioned.

The reactive compounds of the absorbent solution can be, by way of non limitative example, amines (primary, secondary, tertiary, cyclic or not, aromatic or not), alkanolamines, amino-acids, amides or ureas.

The reactive compounds comprising an amine function preferably have the following structure: 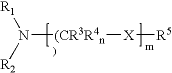
wherein:

X represents an amine function (N—R⁶) or an oxygen atom (O) or a sulfur atom (S) or a fluorine atom (F) or a disulfide (S—S) or a carbonyl function (C═O) or a carboxyl function (O═C—O) or an amide function (O═C—N—R⁶) or a phenyl or a nitrile function (CN) or a nitro group (NO2),

n and m are integers. n can have any value from 0 to 8, preferably from 0 to 6, and m any value from 1 to 7, preferably from 1 to 5,

R⁵ represents either a hydrogen atom or a hydrocarbon chain, branched or not, saturated or not, comprising 1 to 12 carbon atoms, preferably 1 to 10 carbon atoms. R⁵ is absent when X represents a nitrile function (CN) or a nitro group (NO₂) or a fluorine atom (F),

R¹, R², R³, R⁴ and R⁶ represent either a hydrogen atom or a hydrocarbon chain, branched or not, saturated or not, comprising 1 to 12 carbon atoms, preferably 1 to 10 carbon atoms, or they have the following structure: 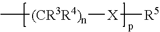
wherein:

n and p are integers. n can have any value from 0 to 8, preferably from 0 to 6, and p any value from 0 to 7, preferably from 0 to 5,

X, R³, R⁴, R⁵ and R⁶ have the same definition as above, they can be respectively identical or of a different nature than the X, R³, R⁴, R⁵ and R⁶ defining the general structure of the reactive compound,

R¹, R², R³, R⁴, R⁵ and R⁶ are defined so as to be possibly bound by a chemical bond in order to form cycles or heterocycles, saturated or not, aromatic or not.

By way of non limitative example, the compounds comprising an amine function can be: monoethanolamine, diethanolamine, triethanolamine, 2-(2-aminoethoxy)ethanol(diglycolamine), N,N-dimethylaminoethoxyethanol, N,N,N′-trimethyl-N′-hydroxyethyl-bisaminoethylether, N,N-bis-(3-dimethylaminopropyl)-N-isopropanol-amine, N-(3-dimethylaminopropyl)-N,N-diiso-propanolamine, N,N-dimethylethanol-amine, N-methylethanolamine, N-methyldiethanolamine, diiso-propanolamine, morpholine, N-methylmorpholine, N-ethylmorpholine, N,N-dimethyl-1,3-propanediamine, N,N,N-tris(3-dimethylaminopropyl)amine, N,N,N′,N′-tetramethyliminobispropylamine, N-(3-amino-propyl)morpholine, 3-methoxy-propylamine, N-(2-aminoethyl)piperazine, bis-(2-dimethylaminoethyl)ether, 2,2-dimorpholinodiethylether, N,N′-dimethylpiperazine, N,N,N′,N′,N″-pentamethyl-diethylenetriamine, N,N,N′,N′,N″-pentamethyldipropylenetriamine, N,N-Bis(2,2-diethoxyethyl)methylamine, 3-butyl-2-(1-ethyl-pentyl) oxazolidine, 3-ethyl-2-methyl-2-(3-methylbutyl)oxazolidine, 1,2,2,6,6-pentamethyl-4-piperidone, 1-(2-methylpropyl)-4-piperidone, N,N,N′,N′-tetraethyl-ethylenediamine, N,N,N′,N′-tetraethylimino-bisethylamine, 1,1,4,7,10,10-hexamethyltriethylenetetramine, 1-phenylpiperazine, 1-formylpiperazine, ethyl 1-piperazinecarboxylate, N,N′-di-tert-butylethylenediamine, 4-ethyl-2-methyl-2-(3-methy-lbutyl)oxazolidine, tetraethylene-pentamine, triethylene-tetramine, N,N-diethyldiethylenetriamine, N1-isopropyl-diethylenetriamine, N,N-dimethyldipropylenetriamine, diethylenetriamine, N-(2-aminoethyl)-1,3-propanediamine, 2,2′-(ethylenedioxy)diethylamine, N-(2-amino-ethyl)morpholine, 4-amino-2,2,6,6-tetramethylpiperidine, 1,2-diaminocyclohexane, 2-piperidinoethylamine, 2-(2-aminoethyl)-1-methylpyrrolidine, ethylenediamine, N,N-diethylethylenediamine, N-phenylethylenediamine, 4,9-dioxa-1,12-dodecanediamine, 4,7,10-trioxa-1,13-tridecanediamine, 1,2,4-trimethylpiperazine, N,N′-diethyl-N,N′-dimethylethylenediamine, N,N-diethyl-N′,N′-dimethylethylenediamine, 1,4,7-trimethyl-1,4,7-triazacyclononane, 1,4-dimethyl-1,4-diazacycloheptane, N-(2-dimethylaminoethyl)-N′-methylpiperazine, N,N,N′,N′-tetraethylpropylenediamine, 1-[2-(1-piperidinyl)ethyl)]piperidine, 4,4′-ethylenedimorpholine, N,N,N′,N′-tetraethyl-N″-methyl-dipropylenetriamine, 4-(dimethylamino)-1,2,2,6,6-pentamethylpiperidine, 1,5,9-trimethyl-1,5,9-triazacyclododecane, 1,4,8,11-tetramethyl-1,4,8,11-tetraazacyclo-tetradecane, N,N′-difurfurylethylenediamine, 1,2-Bis(2-aminoethyl)thioethane, Bis(2-aminoethyl)disulfide, Bis(2-dimethylaminoethyl)sulfide, 1-acethyl-2-diethylamino-ethane, 1-amino-2-benzylaminoethane, 1-acethyl-3-dimethylaminopropane, 1-dimethyl-amino-3,3-diphenylpropane, 2-(dimethylamino-methyl)thiophene, N,N,5-trimethyl-furfurylamine, N,N-Bis(tetrahydro-2-furanyl-methyl)amine, 2-(ethylsulfanyl)ethanamine, thiomorpholine, 2-[(2-aminoethyl)sulfanyl]ethanol, 3-thiomorpholinyl-methanol, 2-(butylamino)ethanethiol, Bis(2-diethylaminoethyl)ether, 1-dimethylamino-2-ethylmethylaminoethoxyethane, 1,2,3-triaminopropane, N˜1˜-(2-aminopropyl)-1,2-propanediamine, N,N-dimethylbenzylamine, N-methylbenzylamine, N-ethyl-benzylamine, N-propylbenzylamine, N-isopropylbenzylamine, N-butylbenzylamine, N-tertiobutylbenzylamine, N-phenetylbenzylamine, N,N′-dibenzylethylenediamine, N′-benzyl-n,n dimethylethylenediamine, dibenzylamine, N-benzylpiperidone, 1,2,3,4-tetrahydroisoquinoline, 1-(2-methoxyphenyl)piperazine, 2-methyl-1-(3-methylphenyl)piperazine, 1-(2-pyridinyl)piperazine, N-methyldiphenylmethanamine, benzhydrylamine, N-benzyl-N′,N′-dimethylethylenediamine, 3-(methylamino)propionitrile, 3-(ethylamino)propionitrile, 3-(dimethylamino)propionitrile, 3-(diethylamino)propionitrile, 3-(propylamino)propionitrile, 3-(butylamino)propionitrile, 3-(tertiobutylamino)propionitrile, 3-(pentylamino)propionitrile, 3-(hexylamino)propionitrile, 3-(cyclohexylamino)propionitrile, 3-aminopropionitrile, 3-(octylamino)propionitrile, 3-(dibutylamino)propionitrile, 3-(1-piperidino)propionitrile, hexahydro-1H-azepine-1-propionitrile, 3-(dipropylamino)propionitrile, 3-piperazinopropionitrile, 1-benzylpiperazine, 2,3-difluorobenzylamines, 4-fluorobenzylamines, 2,3-difluoro-N-methylbenzylamines, 4-fluoro-N-methylbenzylamines, 1-(4-fluorobenzyl)piperazine, 1-(2-fluorobenzyl)piperazine, 2,3-fluorophenetylamines, 4-fluorophenetylamines, 1-(2-fluorophenyl)piperazine, 1-(4-fluorophenyl)piperazine, 3-fluoropyrrolidone, 3-trifluoromethylpiperidine, 4-trifluoromethylpiperidine and trifluoromethyl-benzylamines.

The absorbent solution can possibly also contain one or more activators for favouring absorption of the compounds to be eliminated. They can be, for example, amines, amino-acids, amino-acid alkaline salts, alkaline metal phosphates, carbonates or borates.

The activators comprising an amine function can preferably have the structure as follows: 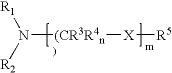
wherein:

X represents an amine function (N—R⁶) or an oxygen atom (O) or a sulfur atom (S) or a fluorine atom (F) or a disulfide (S—S) or a carbonyl function (C═O) or a carboxyl function (O═C—O) or an amide function (O═C—N—R⁶), a phenyl or a nitrile function (CN) or a nitro group (NO₂),

n and m are integers. n can have any value from 0 to 8, preferably from 0 to 6, and m any value from 1 to 7, preferably from 1 to 5,

R⁵ represents either a hydrogen atom or a hydrocarbon chain, branched or not, saturated or not, comprising 1 to 12 carbon atoms, preferably 1 to 10 carbon atoms. R⁵ is absent when X represents a cyano function (CN) or a nitro group (NO₂), or a fluorine atom (F),

R¹, R², R³, R⁴ and R⁶ represent either a hydrogen atom or a hydrocarbon chain, branched or not, saturated or not, comprising 1 to 12 carbon atoms, preferably 1 to 10 carbon atoms, or they have the following structure: 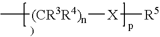
wherein:

n and p are integers. n can have any value from 0 to 8, preferably from 0 to 6, and p any value from 0 to 7, preferably from 0 to 5,

X, R³, R⁴, R⁵ and R⁶ have the same definition as above, they can be respectively identical or of a different nature in X, R³, R⁴, R⁵ and R⁶ defining the general structure of the activator,

R¹, R², R³, R⁴, R⁵ and R⁶ are selected so as to be possibly bound by a chemical bond in order to form cycles or heterocycles, saturated or not, aromatic or not,

R¹, R² and R⁶ are selected in such a way that at least one of them represents a hydrogen atom.

The activator concentration ranges between 0 and 30% by weight, preferably between 0 and 15% by weight of the absorbent solution.

The activators can for example be selected from the following list: monoethanolamine, diethanolamine, 2-(2-aminoethoxy)ethanol(diglycolamine), N-methylethanolamine, N-ethylethanolamine, N-propylethanolamine, N-butylethanol-amine, N-(2-amino ethyl)ethanolamine, diisopropanolamine, 3-amino-1-propanol, morpholine, N,N-dimethyl-1,3-propanediamine, N,N,N′,N′-tetramethyl-iminobispropylamine, N-(3-aminopropyl)morpholine, 3-methoxypropylamine, 3-ethoxypropylamine, N-(2-aminoethyl)piperazine, N-(3-aminopropyl)piperazine, N,N,N′,N′-tetraethyliminobisethylamine, 1-phenylpiperazine, 1-formylpiperazine, ethyl 1-piperazinecarboxylate, N,N′-di-tert-butylethylenediamine, 4-ethyl-2-methyl-2-(3-methylbutyl)oxazolidine, tetraethylenepentamine, triethylenetetramine, N,N-diethyldiethylenetriamine, N˜1˜-isopropyldiethylenetriamine, N,N-dimethyl-dipropylenetriamine, dipropylenetriamine, diethylenetriamine, N-(2-aminoethyl)-1,3-propanediamine, 2,2′-(ethylenedioxy)diethylamine, N-(2-amino-ethyl)morpholine, 4-amino-2,2,6,6-tetramethylpiperidine, N-(2-aminoethyl)piperidine, N-(3-aminopropyl)piperidine, 1,2-diaminocyclohexane, N-cyclohexyl-1,3-propane-diamine, 2-piperidino-ethylamine, 2-(2-aminoethyl)-1-methylpyrrolidine, ethylenediamine, N,N-diethyl-ethylenediamine, N-phenylethylenediamine, 4,9-dioxa-1,12-dodecanediamine, 4,7,10-trioxa-1,13-tridecanediamine, furfurylamine, N,N′-difurfuryl-ethylenediamine, 1,2-Bis(2-aminoethyl)thioethane, Bis(2-aminoethyl)disulfide, Bis(aminoethyl)sulfide, 1-amino-2-benzylaminoethane, 2-(aminomethyl)thiophene, N,N-Bis(tetrahydro-2-furanylmethyl)amine, 2-(ethylsulfanyl)ethanamine, thiomorpholine, 2-[(2-aminoethyl)sulfanyl]ethanol, 2-(butylamino)ethanethiol, 1,2,3-triaminopropane, 1,3-diaminopropane, 1,4-diaminobutane, 1,5-diaminopentane, hexamethylenediamine, 1,2-propanediamine, 2-methyl-1,2-propanediamine, 2-methylpiperazine, N˜2˜,N˜2˜-dimethyl-1 ,2-propanediamine, N˜1˜,N˜1˜-dimethyl-1,2-propanediamine, 2,6-dimethylpiperazine, 1-ethyl-3-piperidinamine, N˜1˜-(2-aminopropyl)-1,2-propanediamine, decahydroquinoxaline, 2,3,5,6-tetramethyl-piperazine, N,N-dimethyl(2-piperidinyl)methanamine, 1-(2-piperidinyl-methyl)piperidine, 2,2-dimethyl-1,3-propanediamine, N˜1˜,N˜3˜,2-trimethyl-1,3-propanediamine, 2-(aminomethyl)-2-methyl-1,3-propanediamine, N˜1˜,N˜1˜,2,2-tetra-methyl-1,3-propanediamine, 1-methoxy-2-propanamine, tetrahydro-2-furanylmethylamine, 2,6-dimethylmorpholine, N-methyl(tetrahydro-2-furanyl)methanamine, N-methylbenzylamine, N-ethylbenzyl-amine, N-propylbenzylamine, N-isopropylbenzylamine, N-butylbenzylamine, N-tertiobutylbenzylamine, N-phenetylbenzylamine, dibenzylamine, 1,2,3,4-tetrahydroisoquinoline, 1-(2-methoxyphenyl)piperazine, 2-methyl-1-(3-methyl-phenyl)piperazine, 1-(2-pyridinyl)piperazine, N-methyldiphenylmethanamine, benzhydrylamine, N-benzyl-N′,N′-dimethylethylenediamine, 3-(methylamino)propionitrile, 3-(ethylamino)propionitrile, 3-(propylamino)propionitrile, 3-(butylamino)propionitrile, 3-(tertiobutylamino)propionitrile, 3-(pentylamino)propionitrile, 3-(hexylamino)propionitrile, 3-(cyclohexylamino)propionitrile, 3-aminopropionitrile, 3-piperazinopropionitrile, 3-(octylamino)propionitrile, 1-benzylpiperazine, 2,3-difluorobenzylamines, 4-fluorobenzylamines, 2,3-difluoro-N-methylbenzylamines, 4-fluoro-N-methylbenzylamines, 1-(4-fluorobenzyl)piperazine, 1-(2-fluorobenzyl)piperazine, 2,3-fluorophenetylamines, 4-fluorophenetylamines, 1-(2-fluorophenyl)piperazine, 1-(4-fluorophenyl)piperazine, 3-fluoropyrrolidone, 3-trifluoromethylpiperidine, 4-trifluoromethylpiperidine and trifluoro-methylbenzylamines.

The absorbent solution rich in reaction products from the reaction between the acid compounds and the reactive compounds of the absorbent solution is discharged from ZA through line 3 and sent to reaction products extraction zone ZE through line 4 by means of pump P1. The absorbent solution is contacted in ZE with the extraction solution introduced through line 16. The extraction solution comprises extraction compounds that absorb in zone ZE said products contained in the absorbent solution.

In FIG. 1, the absorbent solution is considered to have a lower density than the extraction solution. The absorbent solution is thus introduced into the bottom of ZE through line 4, the extraction solution being introduced at the top through line 16. The invention is however not limited to this configuration. The principle of the invention remains identical if the extraction solution has the lower density. In this case, the extraction solution is obtained in the upper phase upon liquid-liquid separation. In the description hereafter, we consider the case where the absorbent solution has the lower density.

Conventional techniques for contacting two weakly or non miscible liquids can be used: plate column, packed column, with random or stacked packing, pulse column, mixer settler in series, membrane contactors, etc. In particular, the advantage of a membrane contactor is that it does not mix the two solutions and therefore that it is not subjected to the separation problem in cases where the settling time is long, which is all the more problematic since the flow rates treated are high. Selection of the equipment depends on the physico-chemical properties of the two solutions.

The products from the reaction between the acid compounds and the reactive compounds of the absorbent solution are then transferred, at least partly, to the extraction solution because of a thermodynamic selectivity in favour of this extraction solution. The reaction products are then discharged from ZE with the extraction solution through line 5. The absorbent solution, at least partly freed of the reaction products, is discharged from extraction zone ZE and recycled to absorption zone ZA through line 20.

The extraction solution is selected for its aptitude to be weakly miscible with the absorbent solution and to extract at least partly the products from the reaction of the absorbent solution with H₂S, CO₂ or SO₂, or mercaptans, or COS or CS₂. The extraction solution can contain one or more compounds.

The extraction compounds of the extraction solution used in the present invention are all those which are weakly miscible with the reactive compounds of the absorbent solution according to the invention in the proportions and conditions described in the invention, and which extract at least partly the products formed by the reaction(s) between one or more acid compounds contained in the gaseous effluent (H₂S, CO₂, SO₂, mercaptans, COS, CS₂) and at least one of the reactive compounds of the absorbent solution.

The extraction solution can contain one or more different compounds.

The extraction compounds can be, by way of non limitative example, water, glycols, polyethyleneglycols, polypropyleneglycols, ethyleneglycol-propyleneglycol copolymers, glycol ethers, thioglycol, thioalcohols, sulfones, sulfoxides, alcohols, ureas, lactames, N-alkylated pyrrolidones, N-alkylated piperidones, cyclotetra-methylenesulfones, N-alkylformamides, N-alkylacetamides, ether-ketones, alkyl phosphates, alkylene carbonates or dialkyl carbonates and their derivatives, as well as ionic liquids. By way of non limitative example, they can be water, tetraethyleneglycoldimethylether, sulfolane, N-methylpyrrolidone, 1,3-dioxan-2-one, propylene carbonate, ethylene carbonate, dimethyl carbonate, diethyl carbonate, diisobutyl carbonate, diphenyl carbonate, glycerol carbonate, dimethylpropylene-urea, N-methylcaprolactame, dimethylformamide, dimethylacetamide, formamide, acetamide, 2-methoxy-2-methyl-3-butanone, 2-methoxy-2-methyl-4-pentanone, 1,8-dihydroxy-3,6-dithiaoctane, 1,4-dithiane-2,5-diol, 2-(methylsulfonyl)ethanol, tetrahydropyrimidone, dimethylthiodipropionate, bis(2-hydroxyethyl)sulfone, 3-mercapto-1,2-propanediol, 2,3-dimercapto-1-propanol, 1,4-dithioerythritol, 2-mercaptobenzimidazole, 2-mercaptobenzothiazole, 2-mercaptothiazoline or tributylphosphate.

The non-aqueous ionic liquid used in the present invention is selected from the group consisting of liquid salts of general formula Q⁺A⁻, wherein Q⁺ represents an ammonium, a phosphonium and/or a sulfonium, and A⁻ represents any anion, organic or inorganic, likely to form a liquid salt at low temperature, i.e. below 100° C. and advantageously at most 85° C., preferably below 50° C.

In the non-aqueous ionic liquid of formula Q⁻A⁻ used according to the invention, the A⁻ anions are preferably selected from among the following anions: halogenides, nitrate, sulfate, alkylsulfates, phosphate, alkylphosphates, acetate, halogenoacetates, tetrafluoroborate, tetrachloroborate, hexafluorophosphate, trifluoro-tris-(pentafluoroethyl)phosphate, hexafluoroantimonate, fluorosulfonate, alkylsulfonates (for example methylsulfonate), perfluoroalkylsulfonates (for example trifluoromethylsulfonate), bis(perfluoroalkylsulfonyl)amidides (for example bis trifluoromethylsulfonyl amidide of formula N(CF₃SO₂)₂—), tris-trifluoromethylsulfonyl methylide of formula C(CF₃SO₂)₃—, bis-trifluoromethylsulfonyl methylide of formula HC(CF₃SO₂)₃—, arenesulfonates, possibly substituted by halogen or halogenoalkyl groups, the tetraphenylborate anion and the tetraphenylborate anions whose aromatic rings are substituted, tetra-(trifluoroacetoxy)-borate, bis-(oxalato)-borate, dicyanamide, tricyanomethylide, and the tetrachloroaluminate anion.

The Q⁺ cations are preferably selected from the group consisting of quaternary phosphonium, quaternary ammonium, quaternary guanidinium and/or quaternary sulfonium. In the formulas hereafter, R¹, R², R³, R⁴, R⁵ and R⁶ represent hydrogen (except for cation NH₄⁺ for NR¹R²R³R⁴⁺), preferably a single substituent representing hydrogen, or hydrocarbyl radicals having 1 to 30 carbon atoms, for example alkyl groups, saturated or not, cycloalkyls or aromatics, aryls or aralkyls, possibly substituted, having 1 to 30 carbon atoms.

R¹, R², R³, R⁴, R⁵ and R⁶ can also represent hydrocarbyl radicals carrying one or more functions selected from the following functions: —CO₂R, —C(O)R, —OR, —C(O)NRR′, —C(O)N(R)NR′R″, —NRR′, —SR, —S(O)R, —S(O)₂R, —SO₃R, —CN, —N(R)P(O)R′R′, —PRR′, —P(O)RR′, —P(OR)(OR′), —P(O)(OR)(OR′), wherein R, R′ and R″, identical or different, represent each hydrogen or hydrocarbyl radicals having 1 to 30 carbon atoms.

The quaternary sulfonium and quaternary guanidinium cations preferably meet one of the following general formulas:
SR¹R²R³⁺ or C(NR¹R²)(NR³R⁴)(NR⁵R⁶)⁺
where R¹, R², R³, R⁴, R⁵ and R⁶, identical or different, are defined as above.

The quaternary ammonium and/or phosphonium Q cations preferably meet one of the general formulas NR¹R²R³R⁴⁺ and PR¹R²R³R⁴⁺, or one of the general formulas R¹R²N═CR³R⁴⁺ and R¹R²P═CR³R4+ wherein R¹, R², R³ and R⁴, identical or different, are defined as above.

The quaternary ammonium and/or phosphonium cations can also be derived from nitrogen-containing and/or phosphorus-containing heterocycles comprising 1, 2 or 3 nitrogen and/or phosphorus atoms, of general formulas: 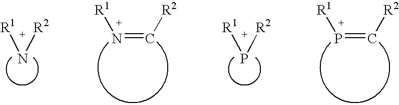
wherein the cycles consist of 4 to 10 atoms, preferably 5 to 6 atoms, and R¹ and R², identical or different, are defined as above.

The quaternary ammonium or phosphonium cation can furthermore meet one of the following general formulas:
R¹R²⁺N═CR³—R⁷—R³C═N⁺R¹R² and R¹R²⁺P═CR³—R⁷—R³C═P⁻R¹R²
wherein R¹, R² and R³, identical or different, are defined as above, and R⁷ represents an alkylene or phenylene radical.

The following radicals can be mentioned from among groups R¹, R², R³ and R⁴: methyl, ethyl, propyl, isopropyl, primary butyl, secondary butyl, tertiary butyl, amyl, phenyl or benzyl; R⁷ can be a methylene, ethylene, propylene or phenylene group.

Preferably, the quaternary ammonium and/or phosphonium Q⁺ cation is selected from the group consisting of N-butylpyridinium, N-ethylpyridinium, pyridinium, ethyl-3-methyl-1-imidazolium, butyl-3-methyl-1-imidazolium, hexyl-3-methyl-1-imidazolium, butyl-3-dimethyl-1,2-imidazolium, the (hydroxy-2-ethyl)-1-methyl-3-imidazolium cation, the (carboxy-2-ethyl)-1-methyl-3-imidazolium cation, diethyl-pyrazolium, N-butyl-N-methylpyrrolidinium, N-butyl-N-methylmorpholinium, trimethylphenylammonium, tetrabutylphosphonium, tributyl-tetradecyl-phosphonium.

Examples of salts that can be used according to the invention are butyl-3-methyl-1-imidazolium bis(trifluoromethylsulfonyl)amidide, triethylammonium bis(trifluoro-methylsulfonyl)amidide, butylimidazolium bis(trifluoromthylsulfonyl)amidide, butyl-3-dimethyl-1,2-imidazolium bis(trifluoromethylsulfonyl)amidide, N-butyl-N-methylpyrrolidinium bis(trifluoromethylsulfonyl)amidide, butyl-3-methyl-1-imidazolium tetrafluoroborate, butyl-3-dimethyl-1,2-imidazolium tetrafluoroborate, ethyl-3-methyl-1-imidazolium tetrafluoroborate, butyl-3-methyl-1-imidazolium hexafluoroantimonate, butyl-3-methyl-1-imidazolium trifluoroacetate, ethyl-3-methyl-1-imidazolium triflate, (hydroxy-2-ethyl)-1-methyl-3-imidazolium bis(trifluoromethyl-sulfonyl)amidide, (carboxy-2-ethyl)-1-methyl-3-imidazolium bis(trifluoromethyl-sulfonyl)amidide, N-butyl-N-methylmorpholinium bis(trifluoromethylsulfonyl)amidide, N,N-ethyl,methylpyrrolidinium bis(trifluoromethylsulfonyl)amidide and N-propyltrimethylammonium bis(trifluoromethylsulfonyl)amidide. These salts can be used alone or in admixture.

The flow rates and the compositions of the absorbent solution and of the extraction solution are suited to the nature of the feed to be treated and to the implementation conditions of the invention.

The extraction solution flow rate can represent 1 to 80% of the mass flow rate of circulation of the absorbent solution, preferably 5 to 60% by weight and ideally 10 to 30%.

The absorbent solution and the extraction solution can also contain anti-corrosion and/or anti-foaming additives. Their nature and concentration are selected depending on the nature of the solutions used, of the feed to be treated and on the implementation conditions. Their concentration in the absorbent solution typically ranges between 0.01%and5%.

The salinity of the absorbent solution and of the extraction solution can possibly be adjusted in order to favour extraction of the products from the reaction of the acid compounds of the gaseous effluent with the reactive compounds of the absorbent solution.

The salts used can be, by way of non limitative example, alkaline, alkaline-earth, metal, amine, quaternary phosphonium, quaternary ammonium, ammonium salts whose nitrogen atom is bound to four carbon atoms, amino-acids or mixtures thereof. The associated anion can be, by way of non limitative example, a halogenide, a phosphate, a pyrophosphate, a sulfite, a sulfate, a hypochlorite, a nitrate, a nitrite, a phosphite, a carboxylate, a bicarbonate, a carbonate, a hydroxide or a mixture. The amine(s) possibly used to obtain these salts can be one or more of the amines present in the absorbent solution as reactive compounds with the acid compounds, or as activator, that are partly neutralized by one or more acids stronger than the acids present in the gaseous effluent treated. The acids used can be, by way of non limitative example, phosphoric acid, pyrophosphoric acid, phosphorous acid, hypochlorous acid, nitrous acid, oxalic acid, acetic acid, formic acid, propanoic acid, butanoic acid, nitric acid, sulfuric acid, sulfurous acid, hydrochloric acid, amino-acids or a mixture. Other amine types neutralized by such acids can also be added to the absorbent solution, for example in form of ammonium salts or of other amine salts or of a mixture of amine salts. Examples thereof are ammonium sulfate, ammonium phosphate or ammonium sulfite. These salts can also result from the partial degradation of the absorbent solution, for example as a result of the reaction of the reactive compounds with a contaminant in the gas treated. The salts can also be obtained after introduction of soda or potash to neutralize acids formed in the plant in which the method is applied. Besides, addition of salts can possibly be avoided in cases where the activators, the reactive compounds or any other additive are by nature salts.

For application of the method according to the invention to the decarbonation of combustion fumes, the decarbonation of natural gas, the decarbonation of cement works gas, the decarbonation of blast-furnace gas, the treatment of Claus tail gas or the desulfurization of natural gas and refinery gas, an absorbent solution associated with an extraction solution selected from the following list can preferably be used:

| Absorbent solution | Extraction solution |
|---|---|
| 3-(octylamino)propionitrile | water |
| 3-(tertiobutylamino)propionitrile | water |
| NN′-dimethylbenzylamine | water |

In case of an application for which selective absorption of H₂S in the presence of CO₂ is required, the absorbent solution then preferably contains a tertiary amine or a greatly encumbered amine and no water. Reaction of the CO₂ with the amine will be limited and therefore disadvantaged in relation to the direct and fast reaction of the amine with H₂S.

The extraction solution laden with reaction products and discharged from ZE through line 5 is sent to the regeneration section. An expansion stage can be carried out in device V1. After expansion, the extraction solution is sent through line 6 to a separating drum BS1. A stream rich in products co-absorbed in the absorbent solution upon gas-liquid contact in ZA and transferred in the extraction solution to ZE is obtained in BS1. It can consist of hydrocarbons, for example in the case of natural gas deacidizing. This gas stream is discharged from BS1 through line 9.

According to the pressure level obtained during expansion, it is possible to carry out partial regeneration of the extraction solution. This phenomenon leads to release an acid gas fraction that is discharged through line 9 and to regenerate part of the reactive compounds of the absorbent solution transferred to the extraction solution as products of the reaction carried out in ZA. A fraction of the absorbent solution immiscible with the extraction solution can then be obtained. In this case, the two liquid phases are separated in BS1. The extraction solution laden with reaction products is discharged through line 7. The reactive compounds of the absorbent solution regenerated during the expansion stage are discharged through line 8. This fraction, once recompressed, can be recycled to absorption zone ZA in admixture with the stream circulating in line 20 or by being directly fed into ZA at an intermediate level between the bottom and the top of the column. This level is determined according to the regeneration quality of this absorbent solution fraction.

Regeneration of the extraction solution can be carried out in a succession of expansion stages. The various absorbent solution fractions obtained with the different expansions can be mixed and recycled to absorption zone ZA after being compressed. They can be recycled with the solution from ZE and sent back to ZA through line 20, or sent back to ZA independently, the injection level of each fraction being determined depending on its regeneration level.

Preferably, the extraction solution coming from BS1 through line 7 is preheated in exchanger E1 and fed into regeneration column RE through line 10. During this thermal regeneration stage, the products of the reaction carried out in ZA are dissociated so as to produce acid gases and a regenerated absorbent solution fraction. The acid gases released are discharged from RE through line 12. The regenerated absorbent solution fraction and the extraction solution are discharged from RE through line 11. The mixture is cooled in E1, the energy released being used to heat the feed sent to RE. After leaving E1, the mixture is possibly fed through line 13 into exchanger E2 in order to control, if need be, the temperature of the mixture according to its recycling to zones ZA and ZE.

This mixture containing the extraction solution and an absorbent solution fraction is thus a two-phase mixture because of the properties of these two solutions. The mixture from E2 is fed through line 14 into a separation device BS2, a drum for example. The extraction solution obtained at the bottom of BS2 is sent back to ZE through lines 15 and 16 and by means of pump P2. The absorbent solution fraction that has settled in BS2 is then discharged through line 17 and recycled to ZA. It can be directly recycled to ZA or mixed with the absorbent solution circulating in line 20. The temperature of the effluents circulating in lines 16 and 17 is adjusted if need be.

A makeup compound supply is provided for example through line 18 for the absorbent solution and line 19 for the extraction solution.

According to the physico-chemical properties of the absorbent solution and of the extraction solution, notably the density of the two solutions, the liquid-liquid separation of the two phases performed in drum BS2 can be carried out at the temperature prevailing in the bottom of column RE. Drum BS2 can then be integrated in the bottom of zone RE. The two liquid phases obtained can be cooled by heat exchange with the effluent circulating in line 7. Additional heat exchangers can be provided in order to adjust the temperature of the two liquid fractions prior to recycling them to zones ZA and ZE.

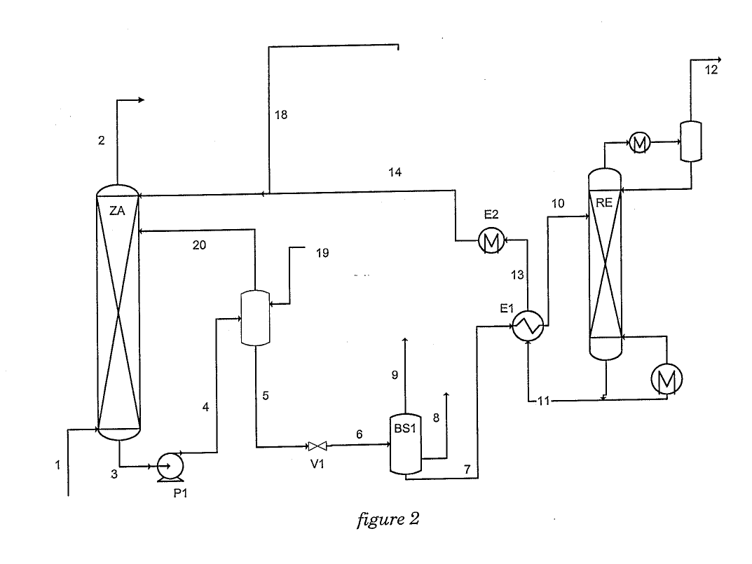

An alternative to the use of two blocks ZA and ZE is to consider a single operation allowing to simultaneously carry out absorption of the acid gases of the gas to be treated in the absorbent solution and transfer of the reaction products from the absorbent solution to the extraction solution. The variant of the method according to the invention shown in FIG. 2 illustrates this alternative. The advantage of this embodiment type is to continuously maintain the driving force of the transfer of the gas to be treated to the absorbent solution by eliminating simultaneously by transfer to the extraction solution the reaction products. The reference numbers of FIG. 2 identical to those of FIG. 1 designate the same elements.

In FIG. 2, stream 14 resulting from the regeneration performed in RE is directly re-injected into ZA. Zone ZA is therefore operated as a gas-liquid-liquid system. The liquid-liquid mixture discharged from ZA through line 3 is sent by means of pump P1 and line 4 to equipment S. The purpose of zone S in the embodiment shown in FIG. 2 is to separate the two liquid phases. S can be, for example, a simple settler. The absorbent solution, at least partly freed of the reaction products, is discharged from zone S through line 20. It can be directly recycled to absorption zone ZA or mixed with the solution flowing in through line 14. The extraction solution laden with reaction products discharged from S through line 5 is sent to regeneration section RE. ZA can be a conventional contacting device such as a bubble column, a plate column, a packed column, with random or stacked packing, stirred reactors in series. ZA can also be a membrane contactor, for example of shell-and-tube type. For example, the gas circulates on the tube side, either cocurrent or countercurrent to the liquids circulating on the shell side. Besides, the two solutions circulate cocurrent to one another on the other shell side.

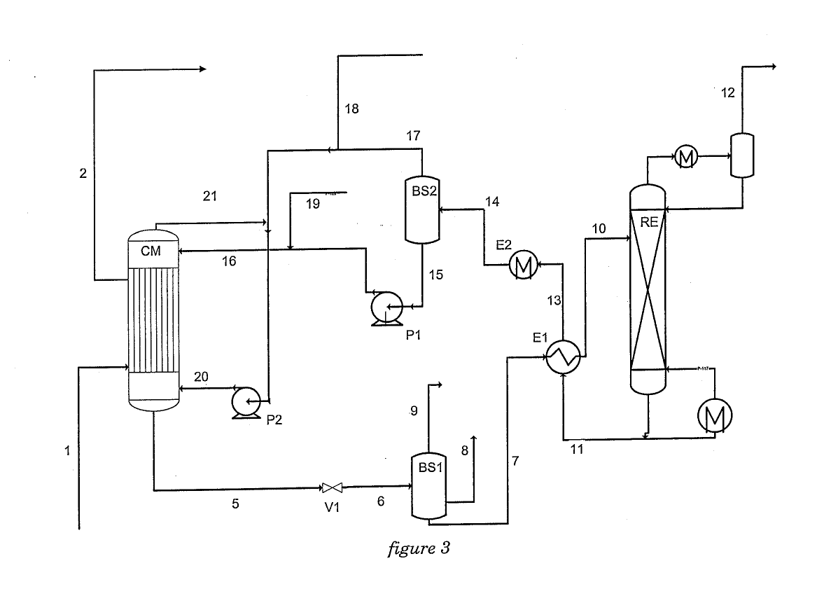

FIG. 3 shows the use of a contactor CM allowing to simultaneously carry out absorption of the acid compounds by the absorbent solution and transfer to the extraction solution of the products formed by the reaction of acid compounds of the effluent with the reactive compounds of the absorbent solution. The reference numbers of FIG. 3 identical to those of FIG. 1 designate the same elements.

Using a contactor CM of membrane contactor type contacting the three phases (gas-liquid-liquid) is particularly suited for the application. A particular advantage thereof is that it continuously maintains, in CM, the driving force of transfer of the gas to be treated to the absorbent solution by eliminating simultaneously by transfer to the extraction solution the reaction products.

The internals of membrane contactor CM can be of shell-and-tube type. The gaseous effluent flowing in through line 1 can circulate on the tube side. The absorbent solution flowing in through line 20 and the extraction solution flowing in through line 16 can circulate countercurrent to one another on the shell side. The absorbent solution can circulate cocurrent to the gaseous effluent, preferably countercurrent thereto.

Separation of the two liquid phases, i.e. the absorbent solution and the extraction solution circulating countercurrent on the shell side, is carried out at the top and at the bottom of equipment CM. In this case, the density of the two liquid phases has to be taken into account when selecting the feed positions. The absorbent solution fraction that has not reacted with the acid compounds of the effluent is discharged from CM through line 21 and mixed with the stream flowing in through line 17 in order to be re-injected into CM through line 20. The product-laden extraction solution is discharged from CM through line 5.

In the embodiment of FIG. 3, it can be interesting not to use separating drum BS2 and to carry out, at the top of CM, the separation of the two phases resulting from the regeneration through line 14.

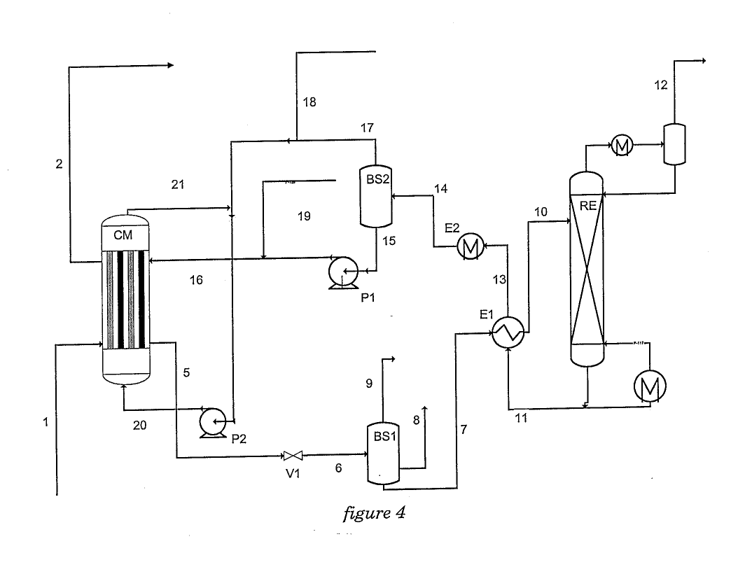

An alternative shown in FIG. 4 consists in circulating the gaseous effluent, the absorbent solution and the extraction solution in three different passages inside CM, these three passages being separated by membranes. The reference numbers of FIG. 4 identical to those of FIG. 3 designate the same elements. For example, the absorbent solution circulates in the shell of membrane contactor CM. Two types of membrane are used in the contactor and distributed for the circulation of the gaseous effluent and of the extraction solution.

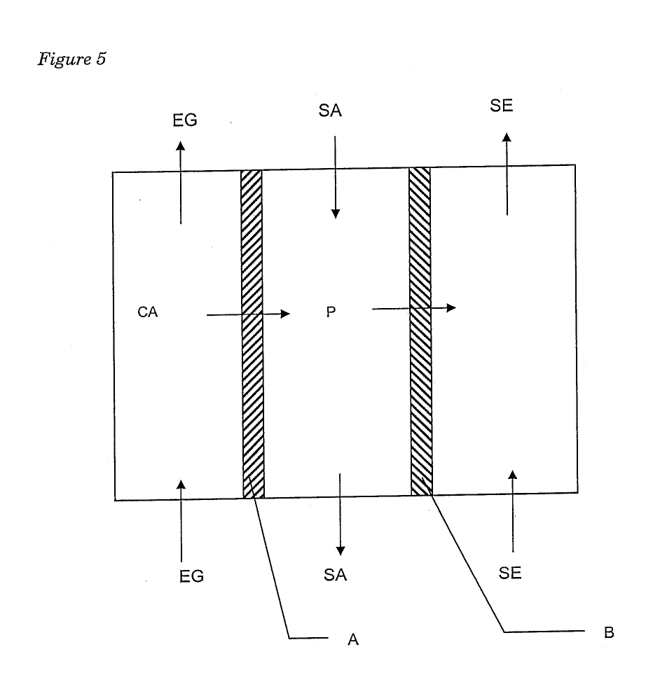

FIG. 5 describes an example of circulation of the various fluids circulating in contactor CM used in the method illustrated by FIG. 4. Gaseous effluent EG circulates upstream from a membrane A permeable to acid compounds CA. Absorbent solution SA circulating downstream from membrane A, preferably countercurrent to gaseous effluent EG upstream from membrane A, allows to absorb acid compounds CA rapidly and therefore favours material transport of the gaseous effluent through membrane A.

According to circumstances, membrane A can be dense or porous. The first option, dense membrane, is the preferred version because it allows to avoid possible breakthrough problems from one phase to the other. Examples of dense materials highly permeable to acid gases are rubbery polymers (of elastomer type) and notably silicone materials such as PDMS (polydimethylsiloxane) or POMS (polyoctylmethylsiloxane). Porous materials of polar nature can be another preferred option for membrane A intended to separate the absorbent solution from the gaseous mixture to be treated. Examples of this category of materials are all the sintered materials based on common oxides (alumina, zirconium oxide, titanium oxide) or metals, or porous polymers such as cellulose acetate, polyimides, polysulfones and derivatives.

Absorbent solution SA is separated from extraction solution SE by a second membrane B. This membrane B must be permeable to products P resulting from the reaction of the acid compounds with the reactive compounds of the absorbent solution. Extraction solution SE circulating downstream from membrane B, preferably countercurrent to absorbent solution SA that is upstream from membrane B, allows to transfer products P rapidly and therefore favours material transport of the absorbent solution through membrane B. Preferably, membrane B is selected porous so as to offer as little resistance as possible to the transfer of these relatively big molecular species. A membrane of polar nature is the preferred option for implementing the invention. Alternatively, membrane B can be of hydrophobic nature. Fluorinated polymer materials such as PTFE (polytetrafluoroethylene) or PVDF (polyvinyl difluoride) come into this category. The two solutions (absorbent solution and extraction solution) can circulate cocurrent or countercurrent.

An excellent geometry for the contactor described above is the hollow fiber. The membrane, whether dense or porous, comes in form of a cylindrical film of diameter below 2 mm. This membrane geometry provides in fact the highest compactness (surface area/volume ratio) in relation to the other membrane geometries (spiral or plane).

Finally, the advantage of membrane contactor CM as described above is that it does not mix the absorbent solution with the extraction solution and therefore that it is not subjected to the separation problem in cases where the settling time is long, which is all the more problematic since the flow rates treated are high. Furthermore, this type of plant allows to vary independently the flow rates of each stream without any impact on the hydrodynamics of the effluents circulating in the other compartments of the contactor.

The numerical example hereafter allows the principle of the invention to be illustrated.

A gaseous mixture containing 10% by volume of CO₂ in nitrogen is contacted at atmospheric pressure at 40° C. with a two-phase liquid-liquid mixture containing 70% by weight of N,N-dimethylbenzylamine and 30% by weight of water. After absorption of the CO₂ and separation of the two liquid phases, analysis of the phases shows that the aqueous phase contains 92% of the products formed by the reaction of the CO₂ with the N,N-dimethylbenzylamine.

1) Method of deacidizing a gaseous effluent comprising at least one of the acid compounds of the group consisting of H₂S, mercaptans, CO₂, COS, SO₂, and CS₂, wherein the following stages are carried out:
a) contacting the acid compounds contained in said effluent with reactive compounds forming a liquid, so as to obtain a gaseous effluent depleted in acid compounds and a first liquid fraction comprising products formed by reaction of the reactive compounds with acid compounds, and reactive compounds that did not react with acid compounds,
b) contacting said products contained in the first liquid fraction with extraction compounds forming a second liquid fraction so as to obtain a product-depleted first liquid fraction and a product-enriched second liquid fraction,
c) recycling to stage a) the first liquid fraction obtained in stage b), said first liquid fraction obtained making up at least part of said liquid,
d) regenerating the second liquid fraction obtained in stage b) so as to release acid compounds in gaseous form and to obtain a mixture of reactive compounds and of extraction compounds,
e) separating the mixture obtained in stage d) into a first stream enriched in reactive compounds and a second stream enriched in extraction compounds, recycling the first stream to stage a) and recycling the second stream to stage b).

2) A method as claimed in claim 1, wherein stage a) is carried out in a first zone and stage b) is carried out in a second zone.

3) A method as claimed in claim 1, wherein stages a) and b) are carried out in a contacting zone.

4) A method as claimed in claim 3, wherein said contacting zone is a membrane contactor in which the gaseous effluent circulates in a passage separated by a membrane from another passage in which the reactive compounds and the extraction compounds circulate.

5) A method as claimed in claim 3, wherein said contacting zone is a membrane contactor in which the gaseous effluent circulates in a first passage separated by a first membrane from a second passage in which the reactive compounds circulate, said second passage being separated by a second membrane from a third passage in which the extraction compounds circulate.

6) A method as claimed in claim 1, wherein said reactive compounds are selected from the list consisting of N,N-dimethylbenzylamine, N-ethylbenzylamine, 3-(octylamino)propionitrile and 3-(tertiobutylamino)propionitrile.

7) A method as claimed in claim 1, wherein said extraction compounds are selected from the list consisting of water, glycol ethers, alkylene carbonates, dialkyl carbonates, sulfolane and N-methylpyrrolidone.
